(19) United States
(12) Patent Application Publication
(10) Pub. No.: US 2007/0012545 A1
(43) Pub. Date: Jan. 18, 2007

(54) Separator and method of use

(75) Inventor: Barton Varney, Binghamton, NY (US)

Correspondence Address: GREENBLUM & BERNSTEIN, P.L.C., 1950 ROLAND CLARKE PLACE, RESTON, VA, 20191, US

(73) Assignee: LOCKHEED MARTIN CORPORATION, Bethesda, MD (US)

(21) Appl. No.: 11/179,468

(22) Filed: Jul. 13, 2005

(51) Int. Cl. B65G 47/46

(52) U.S. Cl. 198/370.04

(57) ABSTRACT

A system and method designed to separate product. The system comprises a dividing mechanism having a first set of directional rollers and a second set of directional rollers, remaining in a single plane. A first conveyor is positioned on a first side of the dividing mechanism and receives products from the first directional mechanism. A second conveyor is positioned on a second side of the dividing mechanism and receives the products from the second directional mechanism.

The U.S. Government has a paid-up license in this invention and the right in limited circumstances to require the patent owner to license others on reasonable terms as provided for by the terms of contract number 3BMHRD-04-D-6136 awarded by the United States Postal Service.

### FIELD OF THE INVENTION

The invention generally relates to a separator system and, more particularly, to a bulk item separator and method of use.

### BACKGROUND DESCRIPTION

The sorting of mail, packages, flats or other product (generally product) is a very complex, time-consuming task. In general, the sorting of product is processed through many stages, including back end processes, which sort or sequence the product in delivery order sequence. These processes can either be manual or automated, depending on the sorting facility, and the type of product to be sorted such as packages, flats, letters and the like. A host of other factors may also contribute to the automation of the sorting, from budgetary concerns to modernization initiatives to access to appropriate technologies to a host of other factors.

In general, most modern facilities have taken major steps toward automation by the implementation of a number of technologies. These technologies include, amongst others, letter sorters, parcel sorters, advanced tray conveyors, flat sorters and the like. As a result of these developments, postal facilities and other mailers have become quite automated over the years, considerably reducing overhead costs and increasing mail throughput.

By way of example, in front end processes, packages or other bulk items, in addition to mail, may be transported from an unloading area to a sorting and sequencing system. These packages or other bulk items, for example, are transported on a single conveyor system to the feeders of the sorting and sequencing system. The product is sorted or sequenced to a certain level, depending on the particular parameters desired by the mailer or postal facility. For example, the United States Postal Service will sequence the product to an actual delivery sequence level.

In this front-end process, a bulk amount of packages and the like, including trays, (generally referred to as product) is removed from intermediate containers and onto a conveyor system. However, the placement of the product on the conveyor is typically in a random order which impedes the preparation of the downstream sorting and/or sequencing. That is, the product is typically placed on the conveyor system in a random, unorganized manner. However, in order to ensure the product stream is adequately prepared for downstream automation or other processing, the product should be in a single file with a bar code on the leading or trailing edge. To accomplish this, a “separator” is employed which is capable of manipulating the product into a more uniform stream for processing.

Singulators are common package separators. Although known singulators may be adequate for limited purposes, there exist many known shortcomings ranging from the inability to handle certain packages such as bulk streams of packages, bundles, boxes or the like, to being too large to fit within a limited, confined floor space, to requiring extensive package manipulation, etc.

By way of examples, in one type of singulator system a series of cascading metal chutes are incorporated at right angles. In addition to the metal chutes, metering belts are used to singulate and de-stack clumps of parcels of various sizes. In another singulator system, a series of thin belts running in parallel with “pop-ups” in between the belts is provided. A vision system detects the location of various products on the narrow belts and an encoder directs the pop-ups to activate, as required, to cause the items to be transported off the singulator one at a time. Another known singular system uses a robotic pallet unloader that employs a large inverted cone to separate the mail stream, followed by a series of conveyor transport modules sized to ensure proper orientation of the product as they exit from the system.

However, in all of these known systems, the footprint or layout is quite large (e.g., exceeding 100 sq./ft), and cannot easily be fitted within a confined floor space. Also, these known systems include complex components which require extensive maintenance and repair, which is costly and time consuming. The existing separators or singulators also do not have the ability to separate bulk streams of packages, bundles, boxes or the like.

The invention is directed to overcoming one or more of the problems as set forth above.

### SUMMARY OF THE INVENTION

In a first aspect of the invention, a separator system comprises a first directional conveying mechanism directing products to a first side thereof and a second directional conveying mechanism directing product to a second side thereof. A first conveyor is positioned on the first side and receives the products from the first directional conveying mechanism. A second conveyor is positioned on the second side and receives the products from the second directional conveying mechanism.

In a second aspect of the invention, the system comprises a dividing mechanism having a first set of directional rollers and a second set of directional rollers, remaining in a single plane. A first conveyor is positioned on a first side of the dividing mechanism and receives products from the first directional mechanism. A second conveyor is positioned on a second side of the dividing mechanism and receives the products from the second directional mechanism.

In another aspect of the invention, a method of dividing product into separate streams includes placing product in an input feeder and metering the product as it passes through an intermediate conveyor to regulate a stream of the product. The method includes dividing the product into at least two streams by: directing a first set of the product to a first direction and a second set of product to a second direction, and sliding the first set of the product to a first conveyor and the second set of the product to a second conveyor. The first set of product and the second set of product are transported on the first conveyor and the second conveyor, respectively.

### BRIEF DESCRIPTION OF THE DRAWINGS

FIG. 1 shows a diagram of the system of the invention; and

FIG. 2 shows an end view of the system of the invention.

### DETAILED DESCRIPTION OF EMBODIMENTS OF THE INVENTION

The invention is directed to separating product for processing or for other end use. The invention is designed for packages and bulk items, but is equally applicable to product such as mail pieces, flats, trays and other mail items. The system of the invention can be modular, and can be utilized in either front or back end processing applications. The system and method of the invention significantly reduces processing times for separating product. Other applications such as warehousing and storage applications are also contemplated for use with the invention.

By using the system of the invention, as will be discussed in greater detail below, the product stream can now be converted from a collective series of unorganized bulk packages into two or more streams of product on different conveyors. This can be performed by metering, dividing and discharging the packages onto independent conveyors.

### System of the Invention

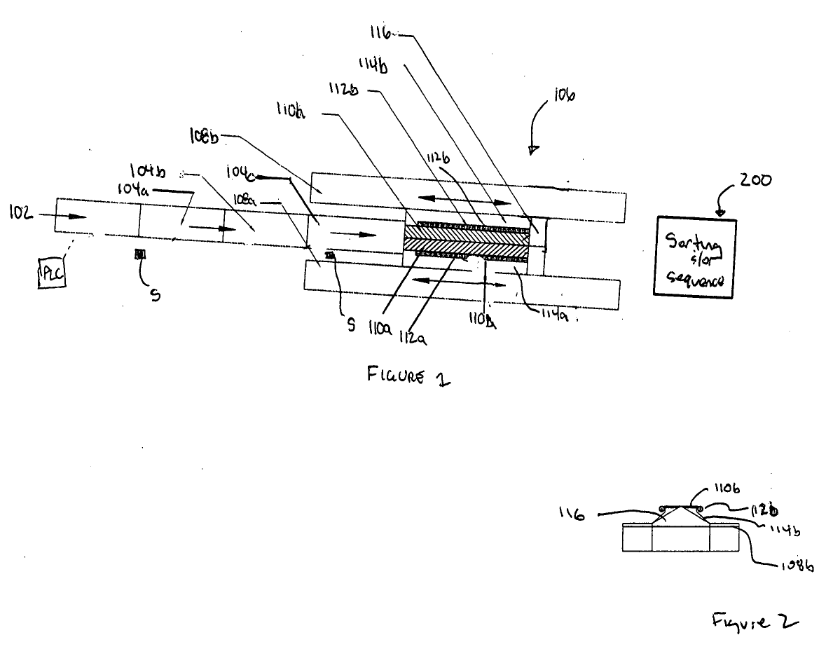

Referring now to FIG. 1, a schematic diagram of the system is shown. In the embodiment of FIG. 1, the system is generally depicted as reference numeral 100 and includes a bulk-feeding conveyor 102. The bulk-feeding conveyor 102 may be any conventional type of conveyor such as a belt conveyor or a power roller conveyor, for example.

The bulk feeding conveyor 102 is coupled to a first separator conveyor 104a, such that product can be fed from the conveyor 102 to the conveyor 104a. In embodiments, the bulk feeding conveyor 102 as well as the conveyor 104a may be a standalone unit. More than one separator conveyor 104a, 104b and 104c is also contemplated for use with the invention; although the invention is not limited to the use of three conveyors, all of which may be modular units.

By way of one non-illustrative example, the product can be controlled and metered via the two or more separator conveyors 104a, 104b and 104c to regulate, e.g., even out, the flow of the product prior to being inducted into a dividing section, generally depicted as reference numeral 106. In embodiments, each successive conveyor 104a, 104b and 104c has a higher coefficient of friction than a previous conveyor so that the product on a preceding conveyor, for example, the conveyor 104a, can be easily transported to the adjacent or successive conveyor, e.g., the second conveyor 104b. Also, it is contemplated by one embodiment of the invention that each successive conveyor 104a, 104b and 104c will run at a faster speed than a previous, upstream conveyor. In this manner, the faster running conveyor will take control of the product during the transition from the previous, upstream conveyor module.

In further embodiments, stopping the previous, upstream conveyor, e.g., conveyor 104a, as the product arrives at the succeeding conveyor, e.g., conveyor 104b, may enhance the controlling effect of the product. This aspect of the invention, as with the other aspects of the invention, may be controlled by a programmable logic controller (PLC) which is capable of collecting signals from photoeyes or other types of sensors designated as reference “S” and strategically placed along the conveyors 104a, 104b and 104c. By this control, the conveyors can be turned “on” or “off” according to the logic scenarios pre-programmed into the PLC. The conveyors may also be pre-programmed to run at different speeds, sense different items, etc.

The sensor may alternatively be a weight sensor, encoder or other device to determine the position of the product. In one implementation, the sensor may provide information to the PLC in order to coordinate movement of the product through the system. For example, in the application of a photodiode, when the product interferes with a light path of the photodiode, the controller PLC may determine that the product is being inducted onto the first metering belt, in order to begin metering operations.

After exiting the conveyor 104a, etc., the product enters the divider section 106 where the product is eventually discharged onto separate side conveyors 108a and 108b. The side conveyors 108a and 108b are bi-directional conveyors, e.g., designed to transport product in two direction, as depicted by the arrows in FIG. 1, once separated or divided. Once divided, the streams continue to flow independently to the end user or other processing such as conventional sorters or sequencing systems 200 such as a sorters or sequencing systems manufactured by Lockheed Martin Corporation. Although two side conveyors are shown, the invention contemplates more than two conveyors, by placing the system in a tiered configuration, for example.

The divider section 106 includes directional rollers 110a and 110b or other type of conveying mechanism such as, for example, belt transports. In one illustrative embodiment, the directional rollers 110a and 110b are directed toward the respective side conveyors 108a and 108b, and more specifically toward respective ejecting rollers 112a and 112b. This facilitates the movement of the product towards the side conveyors 108a and 108b. In one non-illustrative example, the directional rollers 110a and 110b are at an angle of approximately 45 degrees from a centerline; although other angles are contemplated with the invention. The directional rollers 110a and 110b, in one embodiment, remain stationary in a plane, e.g., do not tilt.

The ejecting rollers 112a and 112b are positioned adjacent to and at a substantially right angle with respect to the directional rollers 110a and 110b. The ejecting rollers 112a and 112b and the angled directional rollers 110a and 110b, in one embodiment, are powered rollers; although, the ejecting rollers 112a and 112b may be freely rotating, passive rollers. Also, the angled directional rollers 110a and 110b may alternatively be separated angled belts, in one example.

In one embodiment, the angled directional rollers 110a and 110b and the ejecting rollers 112a and 112b are positioned at a height higher than the side conveyors 108a and 108b. This enables the product to slide downwards on the slides 114a and 114b, respectively, to the respective side conveyors 108a and 108b. Thus, the slides facilitate the transport of the product from the angled directional rollers 110a and 110b to the respective side conveyors 108a and 108b.

An end flow-splitting ridge 116 is positioned at a distal end of the angled directional rollers 110a and 110b. The end flow-splitting ridge 116 will ensure that a product that was riding along the centerline of the angled directional rollers 110a and 110b will fall to either of the side conveyors 108a and 108b. The end flow-splitting ridge 116 thus prevents the product from remaining on the device 106, at a distal end of the along the angled directional rollers 110a and 110b. The end flow-splitting ridge 116, in one embodiment, includes opposing sloped walls to direct the product to either of the side conveyors 108a and 108b.

FIG. 2 is an end view of the system of the invention. In this view, it is shown that the angled directional rollers 110a and 110b and the ejecting rollers 112a and 112b are positioned at a height slightly higher than the side conveyors 108a and 108b. Also, FIG. 2 shows the slides 114a and 114b positioned between the ejecting rollers 112a and 112b and the side conveyors 108a and 108b. This facilitates the movement of the product from the angled directional rollers 110a and 110b to the side conveyors 108a and 108b. The end flow-splitting ridge 116 is shown to be opposing sloped walls to direct the product to either of the side conveyors 108a and 108b.

### Example of using the System of the Invention

The following is an illustrative example of using the system of the invention. This example should not be construed as limiting the features of the invention. The system of the invention may be used for a single carrier route at a time, multiple routes at once or for warehousing or other processing needs of products such as bulk packages, boxes and the like. Also, some or all of the different operational stages described herein may be coordinated by the controller, PLC, and performed synchronously or asynchronously with two or more of the systems described herein.

The product is placed on the bulk-feeding conveyor 102, as intake product. The product is transported to the first separator conveyor 104a to even out the flow of the product. In embodiments, the product will be fed through more than one separator conveyor to even out the flow of the product prior to being inducted into the dividing section 106.

The conveyors may even the flow of the product by having each successive conveyor with a higher coefficient of friction than a previous conveyor so that the product on a preceding conveyor can be “grabbed” by the adjacent or successive conveyor. Also, each successive conveyor 104a, 104b and 104c may be run at a faster speed than a previous, upstream conveyor. The PLC may control the speed of the conveyors, as well as the run and stop times based on product flow, e.g., a product sensed by the system.

The product enters the divider section 106 in an even flow, where the product is discharged onto two separate side conveyors 108a and 108b. By example, the product will flow onto the angled directional rollers 110a and 110b which, in turn, direct the product towards the side, e.g., towards the discharge ejecting rollers 112a and 112b. The product will be caught by the discharge ejecting rollers 112a and 112b and discharged onto the respective slides.

The slides 112a and 112b transport the product to the respective side conveyors 108a and 108b. The slides facilitate the transport of the product from the angled directional rollers 110a and 110b to the respective side conveyors 108a and 108b. An end flow-splitting ridge 116 prevents the product from sliding off of the device 106. The product is transported on the separate conveyors, in either direction, to the end user or further processing such as a sorter or sequencer for ordering to a certain level.

The end flow-splitting ridge 116, in one embodiment, includes opposing sloped walls to direct the product to either of the side conveyors 108a and 108b. By using the end flow-splitting ridge 116, product riding along the centerline of the angled rollers will be directed to any of the conveyors. This will prevent the product from remaining on the device, without being transported to the conveyors.

While the invention has been described in terms of embodiments, those skilled in the art will recognize that the invention can be practiced with modification within the spirit and scope of the appended claims.

It is claimed:

1. A system, comprising:
a first directional conveying mechanism directing product to a first side thereof,
a second directional conveying mechanism directing product to a second side thereof;
a first conveyor positioned on the first side and receiving the products from the first directional conveying mechanism; and
a second conveyor positioned on the second side and receiving the products from the second directional conveying mechanism.

2. The system of claim 1, wherein the first directional conveying mechanism and the second directional conveying mechanism remain stationary in a plane.

3. The system of claim 1, wherein the first directional conveying mechanism and the second directional conveying mechanism comprises directional rollers, the directional rollers of the first directional conveying mechanism face in a direction different than that of the directional rollers of the second directional conveying mechanism.

4. The system of claim 1, wherein the first conveyor and the second conveyor are bi-directional transports.

5. The system of claim 1, further comprising:
a first slide positioned between the first directional conveying mechanism and the first conveyor; and
a second slide positioned between the second directional conveying mechanism and the second conveyor.

6. The system of claim 5, further comprising:
a first ejection mechanism positioned between the first slide and the first directional conveying mechanism, the first ejection mechanism ejecting the products from the first directional conveying mechanism onto the first slide; and
a second ejection mechanism positioned between the second slide and the second directional conveying mechanism, the second ejection mechanism ejecting the products from the second directional conveying mechanism onto the second slide.

7. The system of claim 5, further comprising an end flow ridge for directing the product to the first conveyor and the second conveyor, respectively.

8. The system of claim 1, further comprising:
a first ejection mechanism positioned between the first directional conveying mechanism and the first conveyor, the first ejection mechanism ejecting the products from the first directional conveying mechanism onto the first conveyor; and
a second ejection mechanism positioned between the second directional conveying mechanism and the second conveyor, the second ejection mechanism ejecting the products from the second directional conveying mechanism onto the second conveyor.

9. The system of claim 8, wherein the first ejection mechanism and the second ejection mechanism are rollers positioned adjacent to the first directional conveying mechanism and the second directional conveying mechanism, respectively, and facing the first conveyor and the second conveyor, respectively.

10. The system of claim 1, further comprising a metering device which regulates flow of the product prior to being inducted onto the first directional conveying mechanism and the second directional conveying mechanism.

11. The system of claim 10, wherein:
the metering device includes at least two separate conveying systems; and
a first of the at least two conveying systems has at least one of a higher coefficient of friction and speed than that of a second of the at least two separate conveying systems.

12. The system of claim 11, further comprising a controller which coordinates the speed of the at least two separate conveying systems.

13. The system of claim 1, wherein the products are at least mail items.

14. A system, comprising:
a dividing mechanism having a first set of directional rollers and a second set of directional rollers, remaining in a single plane;
a first conveyor positioned on a first side of the dividing mechanism and receiving products from the first set of directional mechanism; and
a second conveyor positioned on a second side of the dividing mechanism and receiving the products from the second set of directional rollers.

15. The system of claim 14, wherein the first and second set of directional rollers is positioned at approximately a 45 degree angle from a centerline.

16. The system of claim 14, further comprising:
a first slide positioned between the first set of directional rollers and the first conveyor; and
a second slide positioned between the second set of directional rollers and the second conveyor.

17. The system of claim 16, further comprising:
a first ejection mechanism positioned between the first slide and the first set of directional rollers, the first ejection mechanism ejecting the dividing mechanism onto the first slide; and
a second ejection mechanism positioned between the second slide and the second set of directional rollers, the second ejection mechanism ejecting the products from the dividing mechanism onto the second slide.

18. The system of claim 17, wherein the first ejection mechanism and the second ejection mechanism are rollers facing the first conveyor and the second directional conveyor, respectively.

19. The system of claim 14, further comprising at least two conveyors which regulates flow of the product prior to be inducted onto the first set of directional rollers and the second set of directional rollers, the at least two conveyor having at least different coefficient of friction and speed and being positioned prior to the dividing mechanism.

20. The system of claim 14, wherein the products are at least mail items.

21. The system of claim 14, further comprising a sorter upstream from at least one of the first conveyor and the second conveyor.

22. A method, comprising:
placing product in an input feeder;
metering the product as it passes through an intermediate conveyor;
dividing the product into at least two streams by:
directing a first set of the product to a first direction and a second set of product to a second direction;
sliding the first set of the product to a first conveyor and the second set of the product to a second conveyor; and
transporting the first set of product and the second set of product on the first conveyor and the second conveyor, respectively, the transporting being in a same or different direction than an original direction.
